(19) United States
(12) Patent Application Publication
(10) Pub. No.: US 2024/0408678 A1
(43) Pub. Date: Dec. 12, 2024

(54) TURNING TOOL HAVING A CUTTING ELEMENT FOR A LATHE THAT USES METAL-CUTTING TECHNOLOGY, AS WELL AS A LATHE AND USE OF A TURNING TOOL

(71) Applicant: Roland Mandler GmbH & Co. KG, Heuchelheim (DE)

(72) Inventor: Roland MANDLER, Heuchelheim (DE)

(73) Assignee: Roland Mandler GmbH & Co. KG, Heuchelheim (DE)

(21) Appl. No.: 18/639,078

(22) Filed: Apr. 18, 2024

(30) Foreign Application Priority Data
Jun. 6, 2023 (EP) 23177687.3

(51) Int. Cl. B23B 27/14

(52) U.S. Cl. CPC B23B 27/145; B23B 2200/166; B23B 2200/202; B23B 2200/286; B23B 2226/31; B23B 2265/16

(57) ABSTRACT

A turning tool has a cutting element for a lathe that uses metal-cutting technology, wherein the cutting element has a tool blade, wherein the tool blade of the cutting element has a curvature, in a top view, in which the tool blade intersects a tool axis of the cutting element at a perpendicular angle, in which the cutting element has an opening angle with reference to a center point, wherein the cutting element has asymmetry, in such a manner that the tool axis intersects the opening angle outside the center, and in which, in a top view of the cutting element, the curvature of the tool blade has a constant change in radius.

### CROSS REFERENCE TO RELATED APPLICATIONS

Applicant claims priority under 35 U.S.C. § 119 of European Application No. 23177687.3 filed Jun. 6, 2023, the disclosure of which is incorporated by reference.

### BACKGROUND OF THE INVENTION

### 1. Field of the Invention

The invention relates to a turning tool having a cutting element for a lathe that uses metal-cutting technology. The invention also relates to a lathe and to use of a turning tool.

### 2. Description of the Related Art

To carry out metal-cutting methods using geometrically determined blades, turning methods using lathes are known. By means of rotation of a workpiece about an axis of rotation, the surface of the workpiece is moved past a tool blade of a cutting element, and the chip is lifted off.

The further movements for producing the cut are mostly clearly slower and shorter, and are generally implemented by means of degrees of freedom of the turning tool. One form of turning is what is called transverse facing. During transverse facing, the tool blade moves transverse to the axis of rotation. In practice, it is also referred to briefly as facing. As the turning result, a planar end face is formed on the workpiece. A related special form of transverse facing is used in the production of optical lens surfaces.

Such a method is described, for example, in DE 10 2011 053 772 B3. Here, the tool blade moves over an end face of a lens blank, from the outside to the inside, relative to the axis of rotation. This motion results in a spiral-shaped work path, due to the rotation of the workpiece, which path is traveled by the tool blade on the workpiece. The transverse movement of the tool blade additionally has a longitudinal movement parallel to the axis of rotation superimposed on it. In the simplest case, this motion serves for the production of a spherical convex or concave surface. Aspherical surfaces having rotation symmetry or free-form surfaces, however, can also be produced in the same manner.

Greater demands on the longitudinal movement of the tool blade exist if free-form surfaces having elevations and depressions on the surface circumference are being produced or if a prismatic gradient is supposed to be produced on the surface. The longitudinal movement is then coupled with the angle of rotation of the lens blank, and must take place forward and back during every rotation. This motion can be done, for example, using fast servomotors such as Fast-Tools, plunger coils, and piezo-actuators.

Possible turning tools used are, in particular, cutting inserts or indexable inserts, such as they are indicated, for example, in AT 305 726 B or EP 2 813 305 B1. These solutions, which are part of the state of the art, have the disadvantage that they have a slow speed of production when carrying out the turning process, due to tool radii of approximately 2 mm and the related high number of revolutions for passing over the entire surface.

This disadvantage is because the speed of rotation cannot be increased simply as desired. Accordingly, the number of items produced by the lathe is low. In the production of eyeglass lenses at a high production volume, in particular, the price for eyeglass lenses that results must be reduced for reasons of economic efficiency.

Using a circular cutting insert having a diameter of 8 mm, such as it is indicated in WO 02/076660 A1, for example, can produce prism angles and gradients on a surface to be lathed only with great restrictions, because the tool is simply too large to produce such structures. It is therefore unsuitable for turning machining of eyeglass lenses.

Furthermore, a turning tool having a cutting element is part of the state of the art (EP 3 970 888 A2), in which the cutting element has a curvature in a top view. The curvature in turn has a constant radius proceeding from a center point. The cutting element usually has a diamond surface, for example one produced of synthetic material, because in order to process plastics, the tool must have a corresponding useful lifetime. This material is relatively expensive. This cutting element, which is part of the state of the art, has the disadvantage that it wears out relatively quickly, because the cutting element comes into contact with the surface to be worked, during chip-removing machining, over only a small area of the machining arc, and as a result is also partially worn away quickly.

### SUMMARY OF THE INVENTION

The technical problem on which the invention is based consists of indicating a turning tool having a cutting element, which tool has a longer useful lifetime and does not wear out so quickly. Furthermore, a lathe is supposed to be indicated, which has fewer down times caused by replacement of the cutting elements. Furthermore, an advantageous use of the turning tool is supposed to be indicated.

This technical problem is solved by means of a turning tool having the characteristics according to one aspect of the invention and by means of a lathe having the characteristics according to another aspect of the invention, and by means of use of a turning tool in accordance with a further aspect of the invention.

The turning tool according to the invention, having a cutting element for a lathe that uses metal-cutting technology, wherein the cutting element has a tool blade,
wherein the tool blade of the cutting element has a curvature in a top view,
in which the tool blade intersects a tool axis of the cutting element at a perpendicular angle,
in which the cutting element has an opening angle with reference to a center point,
wherein the cutting element has asymmetry, in such a manner that the tool axis intersects the opening angle outside the center,
   is characterized in that in a top view of the cutting element, the curvature of the tool blade has a constant change in radius.

The advantage of the turning tool according to the invention lies in that because of the curvature of the tool blade of the cutting element, with a constant change in radius, the cutting element no longer lies against the workpiece with only one point—seen in a top view of the cutting element—but rather because of the change in the radius of the cutting element, a clearly greater arc range is in use. As a result, lesser wear is achieved instead of a strongly point-like stress, as is the case for the state of the art. The machining surface of the cutting element becomes greater as the result of the constant change in radius.

The constant change in radius relates to a center point, in each instance. Each curvature section of the curvature of the tool blade has a radius assigned to it and a center point assigned to it.

The constant change in radius means that the curvature of the tool blade is composed of a plurality of different radii. A constant curve is formed. No projections or setbacks in the curvature of the tool blade are provided. The constant change in radius means that a continuous change in radius is present.

The workpiece, for example a lens blank, usually rotates under the cutting element. The cutting element is moved in two axes relative to the workpiece.

For one thing, the cutting element is lowered in the direction of the workpiece, until it comes into contact with the surface of the workpiece. As the cutting element is lowered further, chip-removing machining of the workpiece takes place.

For another thing, the cutting element is moved radially, from the outside to the inside, and, if applicable, also from the inside to the outside, relative to the workpiece. In this way, the surface of the rotating workpiece can be removed by removing chips.

The cutting element has a base surface. In a top view of the cutting element, the side of the base surface that faces the workpiece is configured to be curved. As a result, the tool blade of the cutting element is configured to be curved. Due to the rotation of the workpiece, the surface of the workpiece that is to be worked performs a relative movement oriented perpendicular to the plane formed by the base surface of the workpiece.

The turning tool according to the invention has the advantage that the cutting element is utilized better than the cutting elements that belong to the state of the art.

By means of the configuration of the cutting element according to the invention, the grooves that are formed in the workpiece during chip-removing machining are also prevented from becoming too large, because a flatter region of the tool comes into contact with the workpiece, specifically toward the edge of the workpiece.

The turning tool according to the invention furthermore has the advantage that even customers of existing machines can install the turning tool.

According to an advantageous embodiment of the invention, the curvature of the tool blade is configured as a section of an ellipsis, as a section of a hyperbola, or as a section of a parabola.

These embodiments have the advantage that the cutting surface of the tool blade becomes flatter toward the edge of the workpiece than is the case in the configuration that belongs to the state of the art, in which the cutting surface has a circular shape. As a result of the flat configuration, the machining angle becomes larger, and the machining arc of the cutting element becomes greater. As a result, the wear is reduced.

According to another advantageous embodiment of the invention, the curvature of the tool blade is configured as a function of the second or higher order.

In this way, too, the cutting surface of the tool blade becomes flatter. Existing mathematical functions can be used for the production of the cutting element, so as to reduce the production effort.

In a further advantageous embodiment of the invention, the curvature of the tool blade of the cutting element has different radii, a carrier element is provided that has a carrier axis oriented parallel and/or coaxial to the tool axis, and the radii of the curvature of the tool blade increase, preferably increase constantly, proceeding from the axis of the cutting element, to the side surfaces, in each instance.

According to this embodiment, in a top view, the cutting element becomes flatter, proceeding from the carrier axis, toward the outside, all the way to the side surfaces, in each instance, than in the case of a circular embodiment of the tool blade.

The axis of the cutting element is arranged offset relative to the carrier axis, so that in a top view, the cutting element has an asymmetrical structure. As a result, one shank becomes flatter than the other shank of the cutting element.

As a result of the increasingly greater radii of the tool blade of the cutting element toward the side surfaces of the cutting element, a greater machining arc engages on the workpiece, in a top view, and thereby the wear of the cutting element is reduced.

It is advantageous if the turning tool according to the invention has the cutting element, which has the tool blade that advantageously is made up of a first material, so that the blade (geometrically) intersects a (geometrical) tool axis of the cutting element at a perpendicular angle.

The cutting element has a constant change in radius. The change in radius relates to a center point, in each instance. It is advantageous if the center point in the case of the embodiment with an ellipsis is the center point of the ellipsis.

In the case of a hyperbola or a parabola, it is advantageous if the center point is the focus of the hyperbola or the parabola.

It is advantageous if the center point lies on the tool axis.

It is advantageous if the turning tool has an opening angle with reference to a center point. In this regard, it is advantageous if it is provided that the radius amounts to between 2.0 mm and 10.0 mm.

The tool blade has an opening angle, with reference to the center point, which amounts to maximally 90 degrees, preferably maximally 70 degrees, further preferably maximally 60 degrees, and particularly preferably maximally 55 degrees.

It is advantageous if the cutting element has asymmetry, in such a manner that the tool axis intersects the opening angle outside of the center (geometrically). The advantage of this configuration is that the productivity can be increased, by means of a change in the radius of the turning tool, as compared to the fixed radii of up to 2.0 mm that are used in the state of the art for the production of eyeglass lenses. This increased productivity is achieved, in particular, by the reduction in the required revolutions for machining the surface. In this regard, the width of the helical channel is continuously increased by means of the tool radius of more than 2.1 mm, without changing the turned surface structure (peak height), in order to be able to polish the subsequent lenses with the standard parameters. In this regard, destructive contacts of the tool blade with surface regions that are not supposed to be worn away during the production of eyeglass lenses are prevented by the asymmetry, although the comparatively large radius of the tool blade is used. In particular, this radius is even further increased by the invention, as compared with the state of the art.

Thus, in the case of a comparison, as an example, of a symmetrical tool blade having a 2 mm radius and an asymmetrical tool blade having a 5 mm radius, the helical channel width increases continuously in the machining of a lens blank, for example from 0.033 mm to 0.053 mm, the number of revolutions for a typical diameter of the lens blank of 65 mm decreases continuously, for example, from approximately 2,000 to 1,250 revolutions, wherein, in each instance, a finished peak height between the helical channels remains constant, at 0.07 μm, for example. The peak heights can also be polished, with at least almost the same amount of effort, when using the cutting element according to the invention. The process time of turning decreases in accordance with the required revolutions at the same speed of rotation, by approximately 37.5%. This value, however, is dependent on the opening angle of the lens to be machined. The greater the opening angle of the lens to be machined, the greater the effect of the continuously increasing tool blade angle.

The cutting element according to the invention can also be used, even without mechanical or control-technology conversion, in many existing machines, so that customer-friendly retrofitting of the solution is available.

According to a further advantageous embodiment, the first material is a synthetic diamond material, in particular from the group of polycrystalline diamond (PCD), chemical vapor deposition (CVD), synthetic mono-crystalline diamond (MCD) and aggregated diamond nano-rods (ADNR), or polycrystalline cubic boron nitride (CBN), or a natural diamond (ND). These hard materials are particularly well suited for processing of high-strength plastics, such as those plastics that must be machined in the production of eyeglass lenses.

The embodiment according to the invention has the advantage that the cutting element according to the invention, advantageously consisting of a diamond material, is optimally used. At a constant diamond size, an increase in radius is provided, so as to increase the useful lifetime of the cutting element.

In a further advantageous embodiment of the invention, the asymmetry is configured in such a manner that the cutting element comes to a more acute point on one side of the tool axis than on the opposite second side of the tool axis. In this way, the amount of the comparatively expensive first material can be reduced, in that in a typically less stressed region of the cutting element, less material is also arranged behind the tool blade.

Furthermore, the asymmetry can advantageously be configured in such a manner that the cutting element, in particular the tool blade, extends farther away from the tool axis on a first side of the tool axis than on the opposite second side of the tool axis. Preferably, the cutting element extends away at least twice as far on the first side than on the second side, furthermore preferably the cutting element extends away at least two and a half times as far on the first side than on the second side, and particularly preferably the cutting element extends away at least three times as far on the first side than on the second side. Maximally, the cutting element should extend away from the tool axis by five times on the first side of the tool axis than on the opposite second side of the tool axis.

It is advantageous if a side surface follows, in each instance, at the ends of the tool blade. The side surfaces form a lateral end of the tool blade and delimit a carrier matrix of the tool blade, in a way. In this regard, the side surfaces can be oriented precisely or at least essentially parallel to one another and/or to the tool axis, or can converge toward one another, starting at the two ends of the tool blade.

With regard to the size conditions, an embodiment is advantageous in which the width of the cutting element, transverse to the tool axis, is greater than the depth along the tool axis. In this way, the amount of the comparatively expensive first material can be reduced. In this regard, the width of the cutting element transverse to the tool axis advantageously lies between 3.0 mm and 6.0 mm. Preferably, the width of the cutting element transverse to the tool axis lies between 3.5 mm and 5.0 mm, and particularly preferably between 3.5 mm and 4.5 mm.

It is advantageous if the cutting element has a back edge that is oriented precisely or at least essentially transverse to the tool axis.

The cutting element can preferably have the basic shape of a small plate, the plate thickness of which is less than the width transverse to the tool axis and less than the depth along the tool axis.

For efficient processing of plastics, in particular plastic eyeglass lenses, a design is suitable, according to which the tool blade is configured positively with a free angle greater than 0°, wherein the free angle preferably amounts to between 0° and 5°.

By means of the two materials of the carrier element and of the cutting element, which are preferably different, a separation of functions, in terms of material technology, is possible between the tasks of positioning and supporting the tool blade and of cutting by means of the tool blade.

It is advantageous that an expensive first material and a comparatively less expensive second material can be used, thereby making the turning tool costs low. Furthermore, the tool blade can be designed primarily for cutting, because of its great hardness, while the carrier element is tougher and less brittle, so as not to break, for example when it is clamped into or screwed onto a turning chisel. Furthermore, heat dissipation and slight damping can be achieved with the carrier element, which is composed of a less hard material. The material property of hardness should be understood, in the present case, in accordance with the hardness scale according to Mohs.

The second material is preferably a material from the group of tungsten or a tungsten alloy, tool steel, boron nitrite, and ceramic. Tungsten materials are particularly well suited for forming high-strength permanent bonds with diamond materials. Tool steel is comparatively inexpensive. Boron nitrite has a high hardness, and thereby the cutting element is mounted particularly precisely and without being damped. Ceramics are also very hard and generally less expensive than tungsten and boron nitrite.

According to an advantageous embodiment, fastening of the cutting element to the carrier element is configured with a friction bond, form bond and/or material bond. Friction-bond connections are very stable, but can cause deformations and can be problematical, in part, depending on the hardness of the first material, because the cutting element can break due to brittleness. Where such problems can arise, therefore, the friction-bond connection is preferably used as a supplement for a form bond and/or material bond.

A form bond allows highly precise fastening and easy positioning during production. In most application cases, however, a form bond alone is insufficient for fastening, and for this reason is preferably supplemented with a friction bond or a material bond.

A material bond already allows a stable permanent connection with good heat conductivity even by itself. Nevertheless, it can be optionally supplemented with a form bond or a friction bond. In this way, the stability and the long-term strength can be increased, and, if applicable, retention protection for the first material, which might be very expensive, can also be provided.

It is particularly advantageous if the carrier element has a rhombic basic shape having two obtuse corners and two acute corners, wherein the cutting element is arranged at or on one of the acute corners.

In this way, the turning tool can be fixed in place in a lathe, in the alignment behind the tool blade, so that the surroundings around the tool blade are as free as possible of physical components that can collide with the workpiece. Furthermore, the rhombic shape is a common negative shape of turning chisels for holding conventional cutting plates, so that the turning tool according to the invention can be used in existing chisels and thereby also in existing lathes.

Accordingly, one design is possible such that the carrier element has the basic form of an indexable insert. In the variant of the turning tool in which the carrier axis and the tool axis are oriented parallel to one another, a lateral offset can optionally exist between the carrier axis and the tool axis, which offset advantageously amounts to between 0.40 cm and 1.10 cm, preferably between 0.55 cm and 0.90 cm, and particularly preferably between 0.60 cm and 0.80 cm.

As the result of the lateral offset, the tool blade is displaced in front of the carrier element, wherein this displacement advantageously takes place in the direction that brings about the result that the tool blade intersects the carrier axis (geometrically) at less of a slant. Accordingly, the center axis of the helical channel then lies more centrally in front of the carrier axis when working on curved end faces. A slight offset, however, can certainly be desirable, because the center line of the helical channel is displaced due to the prismatic slant of the machined surface as compared with a purely planar surface.

Preferably, the carrier element has a fastening hole for fixing a turning chisel in place. In this way, rapid assembly and rapid replacement of the turning tool can be achieved, for example by means of a fastening screw. The turning tool can also have a turning chisel. The carrier element is fixed in place on the latter, in a mecha-nically releasable manner, for example by means of a fastening screw. It is therefore advantageous if the turning chisel is a component separate from the carrier element. The chisel preferably has an installation shaft for being fixed in place in a tool holder of a lathe. In this regard, the turning chisel preferably consists of tool steel.

According to a further advantageous embodiment of the invention, it is provided that a transponder is arranged in or on the turning tool.

Transponders are made up of an integrated microelectronic component (IC) and a resonance capacitor and an antenna coil, wherein the resonance capacitor is frequently already integrated into the microelectronic component. The antenna coil and the resonance capacitor form an electrical oscillating circuit and are tuned to their operating frequency of 13.56 MHZ, for example.

If a transponder gets into the detection range of an RFID antenna system (RFID-Radio Frequency Identification), transmission of data from and to the transponder takes place. The data transmission is based on the magnetic coupling of the alternating fields of the reader and of the transponder in the immediate vicinity of the at least one antenna.

If a transponder is arranged in the region of an antenna, identification data can be read out by the transponder, for example so as to check whether the correct tool is being used. Data can also be transmitted to the transponder, for example so as to store the operating hours of the tool in memory in the transponder.

The data of the transponder can be automatically read into the lathe. In this way, it is possible for the lathe to carry out compensation automatically.

A further advantageous embodiment of the invention relates to a lathe having a turning tool and having a workpiece spindle for holding and rotating a workpiece about an axis of rotation, which is characterized in that the axis of rotation and the tool axis for machining an end face of the workpiece are oriented precisely or at least essentially parallel to one another, and that the cutting element and the workpiece spindle are driven to move, relative to one another, in two or three machine axis directions, using a setting drive.

Using this lathe, it is now possible to produce curved end faces particularly quickly, due to the flatter tool blade with the constant radius change toward the side surfaces. It is advantageous that, for example, the end face of a lens blank can be traversed with the tool blade from the outside to the inside, relative to the axis of rotation. Due to the rotation of the workpiece, a helical work path is obtained, which the tool blade traverses on the workpiece. The transverse movement of the tool blade additionally has a longitudinal movement parallel to or at least essentially directed in the same direction as the axis of rotation superimposed on it.

Preferably, the setting drive has a servomotor such as a Fast-Tool, an immersion coil or a piezo-actuator. Furthermore, the opportunity exists of using a setting drive with a cross table, so as to form the machine axes.

Preferably, one of the machine axis directions is oriented at least essentially or precisely parallel to the carrier axis.

The lathe can advantageously be operated with a first turning tool and a second turning tool, the tool radii of which are smaller than the tool radii of the first turning tool, in such a manner that a decision is made, by means of decision logics, whether the machining of a pre-defined processing surface of a workpiece is to be carried out with the first turning tool or the second turning tool, wherein the decision logics determine a maximum surface curvature to be produced and match it with a defined limit value and/or determine a maximum prism angle to be produced and match it with a defined limit value, and wherein if one of the limit values is exceeded, the second turning tool is used for machining instead of the first turning tool.

Using the method, it is ensured, for example in the production of eyeglass lenses using constantly changing surface geometries and lens blank curvatures, that whenever possible, the first turning tool is used, because it works faster because of the greater tool radii. Whenever the wide tool radius cannot produce the target surface, due to an overly steep prism angle or an overly tight radius, however, recourse is taken to the second turning tool, which has smaller tool radii.

The method optionally takes place in such a manner that the decision logics take place automatically, using a control unit, and the first or second turning tool is turned on and used automatically. In this way, a fully automated process sequence is made possible in the CNC production process, which is generally automated anyway, for example in the production of eyeglass lenses.

In a further method for the operation of a lathe having a first turning tool, it is provided that a concave end face is produced on the workpiece, by means of chip removal, in that the workpiece is driven to rotate about an axis of rotation, and the turning tool is moved toward the axis of rotation from the outside to the inside, wherein the axis of rotation and the tool axis for machining the end face are oriented precisely or at least essentially parallel to one another, and wherein the turning tool is oriented so that the center point lies between the tool axis and the axis of rotation.

Accordingly, based on the half of the concave workpiece that is to be traversed on one side, a suitable orientation of the asymmetrical tool blade is implemented. Fundamentally, in this regard, a lens axis of the workpiece can be oriented coaxial to the axis of rotation. Alternatively, however, it is also possible that the workpiece is held prismatically on a workpiece holder, preferably blocked up, so that a lens axis of the workpiece has an angle greater than 0°, preferably between 0.20° and 2.00°, further preferably between 0.50° and 1.80°, and particularly preferably between 0.80° and 1.50° relative to the axis of rotation. By means of this angle, unwanted collisions of the workpiece with the tool blade can be prevented, so that in addition to the surfaces that can be machined with the first turning tool, in any case, further surface geometries can be quickly produced. In this way, the number of lens blanks that have to be machined using a turning tool having smaller tool radii, for example, is reduced.

The invention furthermore relates to use of a turning tool having a cutting element in the production of curved surfaces, by means of chip removal, in a turning process. In the case of this use, as well, great efficiency is achieved by means of the flatter configuration of the tool blade of the cutting element.

The method and the use are particularly advantageous if the workpiece is a lens blank composed of a transparent or translucent material. The method and the use are also particularly advantageous if the workpiece is processed to produce an optical lens, in particular an eyeglass lens, and, very particularly, to produce a prescription lens having an aspherical surface or a free-form surface.

### BRIEF DESCRIPTION OF THE DRAWINGS

Other objects and features of the invention will become apparent from the following detailed description considered in connection with the accompanying drawings. It is to be understood, however, that the drawings are designed as an illustration only and not as a definition of the limits of the invention.

In the drawings,

FIG. 1 shows a schematic top view of a turning tool having a cutting element;

FIG. 2 shows an amended exemplary embodiment of a cutting element in a top view;

FIG. 3 shows a side view of the turning tool according to FIG. 1, having an additional turning chisel;

FIG. 4 shows a schematic drawing of a lathe having the turning tool according to FIG. 1, as well as a workpiece;

FIG. 5 shows a perspective view of a turning tool having a cutting element;

FIG. 6 shows a schematic representation of a cutting element during a machining process;

FIG. 7 shows a top view of a cutting element according to the invention;

FIG. 8 shows a top view of a cutting element according to the state of the art;

FIG. 9 shows a top view of a cutting element in the machining of a center region of a lens blank; and

FIG. 10 shows a top view of a cutting element in the machining of an edge region of a lens blank.

### DETAILED DESCRIPTION OF PREFERRED EMBODIMENTS

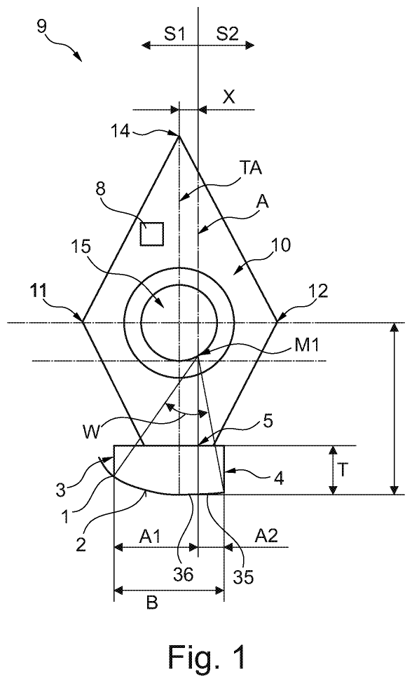

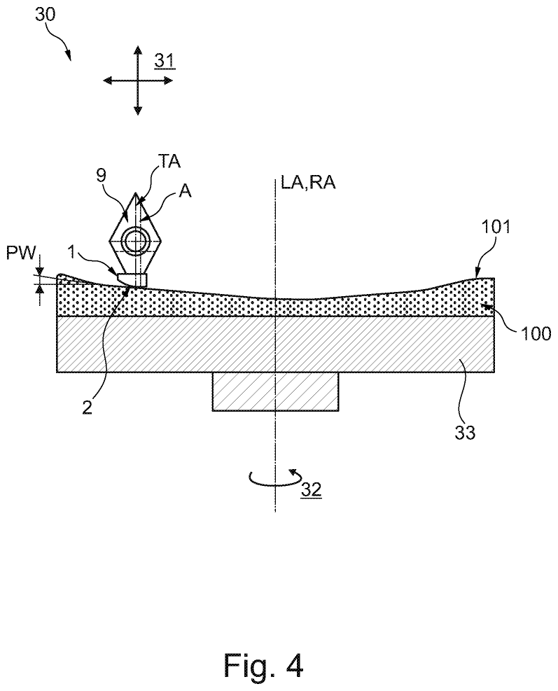

FIG. 1 shows a schematic top view of a turning tool 9 having a cutting element 1 for a lathe (shown in FIG. 4 with the reference number 30) that uses metal-cutting technology, which tool is arranged on a carrier element 10.

The cutting element 1 has a tool blade 2, which has a curvature in a top view, in the present case the shape of an ellipsis section.

Proceeding from an axis A, the radii of the ellipsis section of the cutting element 1 are the same, in the direction of the side surfaces 3, 4, in each instance. The axis A is the axis of symmetry of the cutting element 1. An ellipsis section 35, which extends in the direction of the side surface 4, has radii that are equal in size to those of an ellipsis section 36, which extends in the direction of the side surface 3.

The cutting element 1 is made up of a first material that is a synthetic diamond material from the group of polycrystalline diamond (PCD), chemical vapor deposition (CVD), synthetic mono-crystalline diamond (MCD) and aggregated diamond nano-rods (ADNR), or polycrystalline cubic boron nitride (CBN), or a natural diamond (ND).

As can be seen in FIG. 1, the cutting element 2 is configured asymmetrically. This asymmetry has the following properties:
The tool axis A intersects the opening angle W outside the center;
on a first side S1 of the tool axis A, a longer section A1 of the tool blade 2 is arranged than the second section A2 on the opposite second side S2 of the tool axis A;
the cutting element 1 comes to a more acute point on the first side S1 of the tool axis A than on the second side S2;
the cutting element 1 extends farther away from the tool axis A on the first side S1 than on the second side S2, here, in particular, by more than three times as far.

At the ends of the tool blade 2, the side surface 3, 4 follows the tool blade 2, in each instance. The side surfaces 3, 4 are oriented parallel to one another and also to the tool axis A.

Opposite the tool blade 2, a straight back edge 5 forms an end of the cutting element 1. The back edge 5 is oriented transverse, in other words perpendicular to the tool axis A.

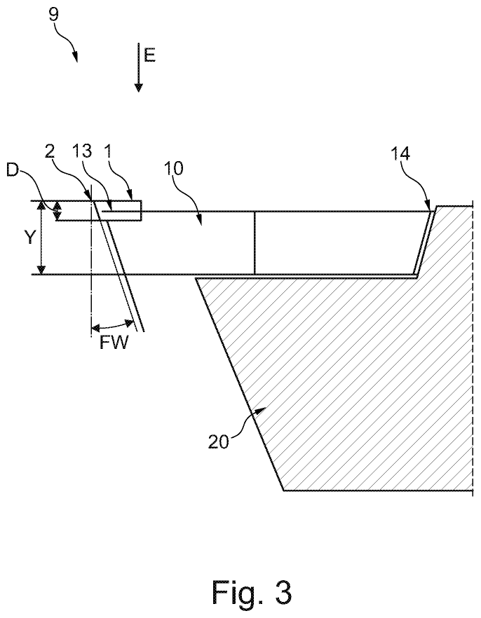

With regard to the relative dimensions, it becomes clear that the width B of the cutting element 1, transverse to the tool axis A, is greater than the depth T along the tool axis A. As can be seen in FIG. 3, the thickness D of the cutting element 1 is less than the depth T along the tool axis A. In absolute values, the width B transverse to the tool axis A can amount, for example, to between 3.5 mm and 4.5 mm.

The top view of the cutting element 1 is indicated in FIG. 3 with the arrow E.

The turning tool 9 according to FIG. 1 has a transponder 8. Data of the turning tool 9 can be stored in the transponder 8, so as to identify the turning tool 9. The data of the transponder 8 can be read into the lathe 30 automatically. In this way, it is possible for the lathe 30 to carry out compensation automatically.

The tool blade 2 has an opening angle W, which must be determined at the center point M1. In other words, the tool blade 2 is defined by an ellipsis section.

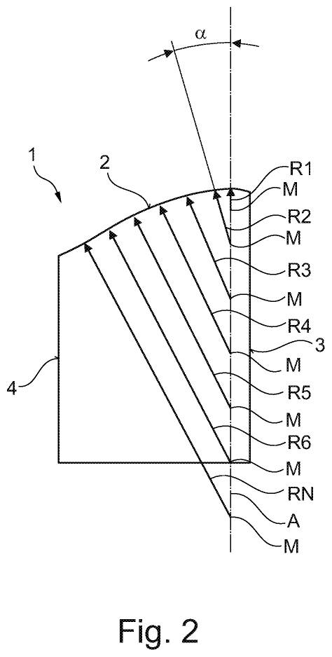

In FIG. 2, a cutting element 1 having a curvature with a function of a higher order is shown in a top view.

The curvature of the tool blade 2 is composed of a plurality of constantly changing radii R1, R2, R3, R4, R5, R6 to RN. Proceeding from the axis A, in the direction of the side surfaces 3, 4 of the cutting element 1, the radii R1, R2, R3, R4, R5, R6 to RN become increasingly greater.

The radii RN preferably lie between 4.5 mm and 5.5 mm.

The smallest radius is the radius R1. This radius coincides with the axis A of the cutting element 2. The tool blade has the side surfaces 3, 4. The radii R2, R3 become greater in the direction of the side surface 3. In other words, R1<R2<R3. This relationship continues up to RN.

In the direction of the side surface 4, the radii also become greater than the radius R1.

Proceeding from the axis A, the radii are the same in both directions toward the side surfaces 3, 4. The axis A is the axis of symmetry of the cutting element 1.

Center points M form the starting points of the radii R1, R2, R3 to RN. The center points M lie on the tool axis A, which intersects the tool blade 2 at a perpendicular angle. The center points M are arranged on the tool axis A offset from one another. The angle & increases with the increasing radii R1, R2 to RN.

As can be seen, above all, in FIG. 3, the tool blade 2 is configured positively with a free angle FW greater than 0°, which amounts, for example, to between 0° and 5°. The carrier element 10 lies behind the free angle FW, set back. In this exemplary embodiment, the front end of the carrier element 10 runs parallel to and offset from the free angle FW. The entire turning tool thickness Y can lie between 2 mm and 4 mm, for example. The carrier element 10 is made up of a second material that has a lesser hardness than the first material (according to the hardness scale according to Mohs). The second material can be a material from the group of tungsten or a tungsten alloy, tool steel, boron nitrite and ceramic.

The carrier element 10 has a carrier axis TA, which is oriented parallel to and offset from the tool axis A by a lateral offset X.

The carrier element 10 has a rhombic basic shape having two obtuse 11, 12 and two acute corners 13, 14, and the carrier axis TA intersects these two acute corners 13, 14. As a result, the carrier element 10 has the basic form of an indexable insert.

The cutting element 1 is arranged on one of the acute corners 13 in such a manner that the tool blade 2 projects beyond this acute corner 13 and the back edge faces in the direction of the other acute corner 14. Fastening of the cutting element 1 to the carrier element 10 is configured with a form bond and/or a material bond. For the form bond, a negative recess for a partial cutout of the cutting element 1 is configured at the acute corner 13. By means of a screw (not shown), which can be screwed in through the fastening hole 15 shown in FIG. 1, in the center of the carrier element 10, into the turning chisel 20 shown in FIG. 3, the carrier element 10 is fixed in place on the turning chisel with a form bond and a friction bond. For the form bond, a negative recess for a partial cutout of the carrier element 10 is configured on the turning chisel 20. The turning chisel 20 is made up of tool steel.

In the schematic drawing of FIG. 4, one can see a lathe 30 having the turning tool according to FIG. 1, as well as a workpiece 100, namely a lens blank, which is blocked onto a workpiece holder 33. The workpiece holder 33 is driven about an axis of rotation RA, using a workpiece spindle 32 that is merely indicated, for holding and rotation of the workpiece 100. A lens axis LA and the axis of rotation RA are oriented coaxially in the present case.

The cutting element 1 and the workpiece spindle 32 are driven to move, relative to one another, using a setting drive 31 that is merely indicated, in two or three machine axis directions.

In FIG. 4, it is furthermore shown how a local prism angle PW can be determined. As is evident, this local prism angle PW is the angle of the end face relative to an imaginary normal plane, with reference to the axis of rotation RA.

Using the lathe 30, it is possible to carry out a method according to which the concave end face of the workpiece 100 is produced by means of chip removal, in that the workpiece 100 is driven to rotate about the axis of rotation RA, and the turning tool 9 is moved from the outside to the inside, in other words toward the axis of rotation RA. In this regard, the axis of rotation RA and the tool axis A are oriented parallel to one another for machining the end face 101.

The turning tool 9 is oriented in such a manner that the center point M lies between the tool axis A and the axis of rotation RA.

The curvature of the tool blade 2, shown in FIG. 1, corresponds to an ellipsis section, as described above.

The curvature can also correspond to a parabola section or a hyperbola section or a function of a higher order. A curvature having a function of a higher order is shown in FIG. 2.

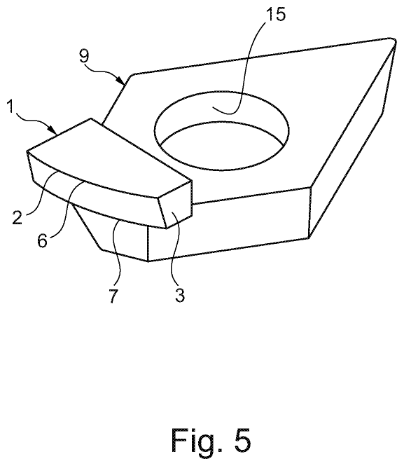

According to FIG. 5, a perspective view of a turning tool 9 is shown. The turning tool 9 carries the cutting element 1. The cutting element 1 has the tool blade 2. Because the cutting element 1 has a curved edge 6, the tool blade 2 is also configured to be curved. The cutting element 2 furthermore has the side surfaces 3, 4, wherein in FIG. 5, only the side surface 3 can be seen.

The cutting element 1 has an edge 6 and an edge 7. The edge 7, seen in the top view of the cutting element 1, lies set back relative to the edge 6, by the free angle FW (FIG. 3). The edge 6 forms the tool blade 2.

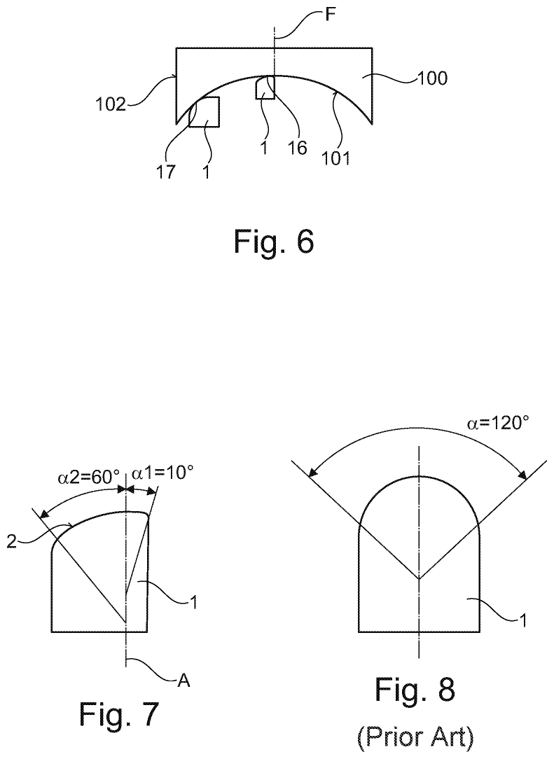

FIG. 6 schematically shows a machining process of a workpiece 100 using a cutting element 1, wherein the turning tool 9 is not shown. Two cutting elements 1 are shown, wherein this depiction represents one and the same cutting element 1 in two different positions. One time, the cutting element is positioned, for machining the end face 101 of the workpiece 100, in the region of a center axis F of the workpiece 100, and another time it is positioned in the direction of the one edge surface 102 of the workpiece 100.

The cutting element 1 lies against the end face 101 of the workpiece 100 merely with a small arc region 16, in the region of the center axis F of the workpiece 100.

If the cutting element 1 is positioned for machining the end face 101 of the workpiece 100, in the direction of the edge surface 102, the cutting element 1 lies against the end face 101 with an arc region 17. The arc region 17 is greater than the arc region 16.

Because the radii R1 to RN of the tool blade 2 of the cutting element 1 become larger from the center axis A to the side surfaces 3, 4, the cutting element 1 lies against the end face 101 with a greater arc region in the edge region of the workpiece 100 than in a center of the workpiece 100.

In FIG. 7, the geometry of the cutting element 1 is shown in a top view. The cutting element 1 has a tool blade 2 having a curvature in the form of an ellipsis section. The angle α1 amounts to 10°, the angle α2 amounts to 60°.

In FIG. 8, a cutting element 1 that belongs to the state of the art is shown, having a tool blade that has a circular section in a top view. Here, the opening angle α=120°.

The cutting elements 1 shown in FIG. 6 and FIG. 7 have effects on a peak height and a peak interval, which are formed in the workpiece 100 during the chip-removing machining using the turning tool.

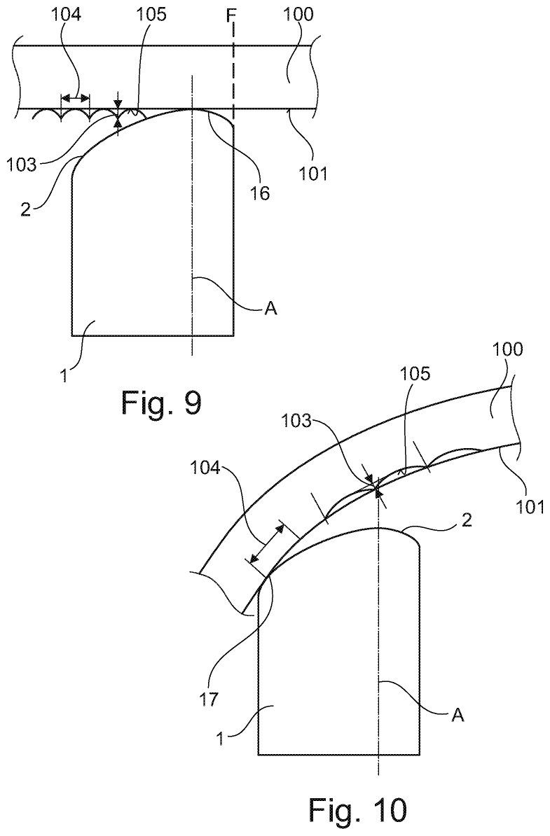

The workpiece 100 rotates at a constant velocity. The cutting element 1 is moved, for example, from the outside, from the edge surface 102, in the direction of the center axis F. During the chip-removing machining, grooves are formed in this regard. The further the cutting element 1 is moved in the direction of the center axis F, the smaller the circumference of the grooves becomes. The grooves have a peak height 103 and a peak interval 104, which are shown in FIGS. 9 and 10.

In the direction of the edge surface 102, the cutting element 1 travels over the greatest circumference. Here, the spiral that is made up of the grooves is the widest. Nevertheless, the peak height is supposed to remain constant.

As shown in FIG. 9, the cutting element 1 is situated in the center of the workpiece 100, as in FIG. 6 in the region of the center axis F. In this region, the end face 101 of the workpiece 100 is flatter than in the edge region. The cutting element 1 lies against the end face 101 with an arc region 16. Grooves having peaks 103 are formed in the end face 101.

As shown in FIG. 10, the cutting element 1 is positioned in the direction of the edge surface 102 of the workpiece 100. The curvature of the end face 101 is greater in this region than the curvature of the end face 101 in FIG. 9.

The cutting element 1 lies against the end face 101 with an arc region 17 for chip-removing machining.

The grooves 105 are greater in FIG. 10, i.e., in the region of the edge surface 102. The peak interval 104 of the grooves 105 is greater in the edge region than in the center of the workpiece 100.

Using the cutting element 1 according to the invention, grooves 105 are produced that have peak heights 103 that remain the same, independent of the position of the cutting element 1 during machining of the end face 101.

The invention is not restricted to one of the embodiments described above, but rather can be modified in many different ways. All of the characteristics and advantages that are evident from the claims, the specification and the drawing, including design details, spatial arrangements, and method steps, can be essential to the invention both in and of themselves and in the most varied combinations.

Although only a few embodiments of the present invention have been shown and described, it is to be understood that many changes and modifications may be made thereunto without departing from the spirit and scope of the invention.

### REFERENCE NUMBERS

1 cutting element
2 tool blade
3 side surface
4 side surface
5 back edge
6 edge of the cutting element 1
7 edge
8 transponder
9 turning tool
carrier element
11 obtuse corner
12 obtuse corner
13 acute corner
14 acute corner
15 fastening hole
16 arc region
17 arc region
20 turning chisel
30 lathe
31 setting drive
32 workpiece spindle
33 workpiece holder
35 ellipsis section
36 ellipsis section
100 workpiece
101 end face
102 edge surface
103 peak height
104 peak interval
105 grooves
A tool axis
A1 first section
A2 second section
B width
D small plate thickness
E arrow
F center axis of workpiece
FW free angle
LA lens axis
M1 center point
M center points
PW prism angle
R1, R2, R3 . . . . RN tool radii
RA axis of rotation
S1 first side
S2 second side
T depth
TA carrier axis
W opening angle
X side offset
Y turning tool thickness

What is claimed is:

1. A turning tool having a cutting element for a lathe that uses metal-cutting technology, wherein the cutting element (1) has a tool blade (2),
wherein the tool blade (2) of the cutting elements (1) has a curvature in a top view,
in which the tool blade (2) intersects a tool axis (A) of the cutting element (1) at a perpendicular angle,
in which the cutting element (1) has an opening angle (W) with reference to a center point (M),
wherein the cutting element (1) has asymmetry, in such a manner that the tool axis (A) intersects the opening angle (W) outside the center, and
wherein in a top view of the cutting element (1), the curvature of the tool blade (2) has a constant change in radius.

2. The turning tool according to claim 1, wherein the curvature of the tool blade (2) is configured as an ellipsis section, as a hyperbola section or as a parabola section.

3. The turning tool according to claim 1, wherein the curvature of the tool blade (2) is configured as a function of the second or higher order.

4. The turning tool according to claim 1,
wherein the curvature of the tool blade (2) of the cutting element (1) has different radii, that a carrier element (10) is provided,
wherein the carrier element (10) has a carrier axis (TA), which is oriented parallel and/or coaxial to the tool axis (A), and
wherein the radii of the curvature of the tool blade (2) increase, proceeding from the axis (A) of the cutting element, in each instance, to the side surfaces (3, 4), preferably increase constantly.

5. The turning tool according to claim 1,
wherein the tool blade comprises a first material, and
wherein the first material is:
a synthetic diamond material, in particular from the group of polycrystalline diamond (PCD), chemical vapor deposition (CVD), synthetic mono-crystalline diamond (MCD) and aggregated diamond nano-rods (ADNR), or
polycrystalline cubic boron nitride (CBN), or
a natural diamond (ND).

6. The turning tool according to claim 1, wherein the asymmetry is configured in such a manner that a longer section (A1) of the tool blade (2) is arranged on a first side (S1) of the tool axis (A) than on the opposite second side (S2) of the tool axis (A).

7. The turning tool according to claim 1, wherein the asymmetry is configured in such a manner that the cutting element (1) comes to a more acute point on a first side (S1) of the tool axis (A) than on the opposite second side (S2) of the tool axis (A).

8. The turning tool according to claim 1, wherein a side surface (3, 4) follows at the ends of the tool blade (2), in each instance.

9. The turning tool according to claim 1,
wherein a width (B) of the cutting elements transverse to the tool axis (A) is greater than the depth (T) along the tool axis (A), and
wherein the width (B) is greater than or equal to 2 millimeters and less than or equal to 10 millimeters.

10. The turning tool according to claim 1,
wherein the tool blade (2) is configured positively with a free angle (FW) greater than 0°, and
wherein the free angle (FW) preferably amounts to between 10° and 25°, further preferably between 14° and 21°, and particularly preferably between 17° and 19°.

11. The turning tool (9) according to claim 1,
wherein a carrier element (10) composed of a second material is provided, and
wherein the first material has a greater hardness than the second material.

12. The turning tool (9) according to claim 11,
wherein the carrier element (10) has a rhombic basic shape having two obtuse (11, 12) and two acute corners (13, 14), and
wherein the cutting element (1) is arranged at or on one of the acute corners (13).

13. The turning tool (9) according to claim 1,
wherein the carrier axis (TA) and the tool axis (A) are oriented parallel to one another, and
wherein a lateral offset (X) exists between the carrier axis (TA) and the tool axis (A), which offset amounts to between 0.40 cm and 1.10 cm, preferably between 0.55 cm and 0.90 cm, and particularly preferably between 0.60 cm and 0.80 cm.

14. The turning tool according to claim 1, wherein a transponder (8) is arranged in the turning tool (9).

15. A lathe (30) having the turning tool (9) according to claim 1 and having a workpiece spindle (32) for holding and rotation of a workpiece (100) about an axis of rotation (RA),
wherein the axis of rotation (RA) and the tool axis (A) for machining an end face (101) of the workpiece (100) are oriented precisely or at least essentially parallel to one another, and
wherein the cutting element (1) and the workpiece spindle (32) are driven to move, relative to one another, in two or three machine axis directions, using a setting drive (31).

16. A method of producing curved surfaces by chip cutting in a turning process, the method comprising:
providing the turning tool according to claim 1, and
using the turning tool in the turning process to the curved surfaces by chip cutting.
